(19) United States
(12) Patent Application Publication
(10) Pub. No.: US 2008/0038558 A1
(43) Pub. Date: Feb. 14, 2008

(54) I-III-VI SEMICONDUCTOR NANOCRYSTALS, I-III-VI WATER STABLE SEMICONDUCTOR NANOCRYSTALS, AND METHODS OF MAKING SAME

(75) Inventors: Daniel LANDRY, Clifton Park, NY (US); Wei LIU, Schenectady, NY (US); Weili SHI, Troy, NY (US); Susanthri PERERA, Latham, NY (US); Alfred WARING, Saratoga Springs, NY (US)

Correspondence Address: KENYON & KENYON LLP, 1500 K STREET N.W., SUITE 700, WASHINGTON, DC, 20005, US

(73) Assignee: EVIDENT TECHNOLOGIES, INC., Troy, NY (US)

(21) Appl. No.: 11/680,344

(22) Filed: Feb. 28, 2007

Related U.S. Application Data
(60) Provisional application No. 60/789,125, filed on Apr. 5, 2006.
(60) Provisional application No. 60/897,940, filed on Jan. 29, 2007.

(51) Int. Cl. B32B 15/02; B05D 5/12; H01B 1/00; B29C 41/40

(52) U.S. Cl. 428/403; 252/500; 427/58

(57) ABSTRACT

A I-III-VI semiconductor nanocrystal composition and method of making same. A water-stable I-III-VI semiconductor nanocrystal complex and method of making same is also provided. A substantially monodisperse population of I-III-VI semiconductor nanocrystal compositions and water-stable I-III-VI semiconductor complexes are further provided.

### CROSS-REFERENCE TO RELATED APPLICATIONS

The present application claims priority to U.S. Provisional Application Ser. No. 60/789,125, filed Apr. 5, 2006, and U.S. Provisional application Ser. No. ______, entitled “Water Soluble Nanocrystals Made of I-III-VI Semiconductor and Related Alloys” filed on Jan. 23, 2007, both of which are incorporated by reference herein.

### FIELD OF THE INVENTION

The present invention relates to semiconductor nanocrystal complexes and particularly to I-III-VI semiconductor nanocrystal complexes. The present invention also relates to water-stable I-III-VI semiconductor nanocrystal complexes.

### BACKGROUND OF THE INVENTION

Semiconductor nanocrystals are crystals of II-VI, III-V, IV-VI materials that have a diameter between 1 nanometer (nm) and 20 nm. More recently other semiconductor nanocrystals made from ternary semiconductors such as I-III-VI semiconductors have been disclosed. In the strong confinement limit, the physical diameter of the nanocrystal is smaller than the bulk exciton Bohr radius causing quantum confinement effects to predominate. In this regime, the nanocrystal is a 0-dimensional system that has both quantized density and energy of electronic states where the actual energy and energy differences between electronic states are a function of both the nanocrystal composition and physical size. Larger nanocrystals have more closely spaced energy states and smaller nanocrystals have the reverse. Because interaction of light and matter is determined by the density and energy of electronic states, many of the optical and electric properties of nanocrystals can be tuned or altered simply by changing the nanocrystal geometry (i.e. physical size).

Single nanocrystals or monodisperse populations of nanocrystals exhibit unique optical properties that are dependent upon the physical size of the nanocrystals. Both the onset of absorption and the photoluminescent wavelength are a function of nanocrystal size and composition. The nanocrystals will absorb all wavelengths shorter than the absorption onset, however, photoluminescence will always occur at the absorption onset. The bandwidth of the photoluminescent spectra is due to both homogeneous and inhomogeneous broadening mechanisms. Homogeneous mechanisms include temperature dependent Doppler broadening and broadening due to the Heisenburg uncertainty principle, while inhomogeneous broadening is due to the size distribution of the nanocrystals. The narrower the size distribution of the nanocrystals, the narrower the full-width half max (FWHM) of the resultant photoluminescent spectra. In 1991, Brus wrote a paper reviewing the theoretical and experimental research conducted on colloidally grown semiconductor nanocrystals, such as cadmium selenide (CdSe) in particular. Brus L., Quantum Crystallites and Nonlinear Optics, Applied Physics A, 53 (1991)). That research, precipitated in the early 1980's by the likes of Efros, Ekimov, and Brus himself, greatly accelerated by the end of the 1980's as demonstrated by the increase in the number of papers concerning colloidally grown semiconductor nanocrystals.

Quantum yield (i.e. the percent of absorbed photons that are reemitted as photons) is influenced largely by the surface quality of the nanocrystal. Photoexcited charge carriers will emit light upon direct recombination but will give up the excitation energy as heat if photon or defect mediated recombination paths are prevalent. Because the nanocrystal may have a large surface area to volume ratio, dislocations present on the surface or adsorbed surface molecules having a significant potential difference from the nanocrystal itself will tend to trap excited state carriers and prevent radioactive recombination and thus reduce quantum yield. It has been shown that quantum yield can be increased by removing surface defects and separating adsorbed surface molecules from the nanocrystal by adding a shell of a semiconductor with a wider bulk bandgap than that of the core semiconductor.

Inorganic colloids have been studied for over a century ever since Michael Faraday's production of gold sols in 1857. Rossetti and Brus began work on semiconductor colloids in 1982 by preparing and studying the luminescent properties of colloids consisting of II-VI semiconductors, namely cadmium sulfide (CdS). (Rossetti, R.; Brus L., Electron-Hole Recombination Emission as a Probe of Surface Chemistry in Aqueous CdS Colloids, J. Phys. Chem., 86, 172 (1982)). In that paper, they describe the preparation and resultant optical properties of CdS colloids, where the mean diameter of the suspended particles is greater than 20 nm. Because the sizes of the particles were greater than the exciton Bohr radius, quantum confinement effects that result in the blue shifting of the fluorescence peak was not observed. However, fluorescence at the bulk band edge energies were observed and had a FWHM of 50-60 nm.

CdS colloids exhibiting quantum confinement effects (blue shifted maxima in the absorption spectra) have been prepared since 1984. (Fotjik A., Henglein A., Ber. Bunsenges. Phys. Chem., 88, (1984); Fischer C., Fotjik A., Henglein A., Ber. Bunsenges. Phys. Chem., (1986)). In 1987, Spanhel and Henglein prepared CdS colloids having mean particle diameters between 4 and 6 nm. (Spanhel L., Henglein A., Photochemistry of Colloidal Semiconductors, Surface Modification and Stability of Strong Luminescing CdS Particles, Am. Chem. Soc., 109 (1987)). The colloids demonstrated quantum confinement effects including the observation of size dependent absorption maxima (first exciton peaks) as well as size dependent fluorescent spectra. The colloids were prepared by bubbling a sulfur containing gas (H₂S) through an alkaline solution containing dissolved cadmium ions. The size and resultant color (of the fluorescence) of the resultant nanocrystals were dependent upon the pH of the solution. The colloids were further modified or “activated” by the addition of cadmium hydroxide to the solution that coated the suspended nanocrystals. The resultant core-shell nanocrystals demonstrated that the quantum yield of the photoluminescence increased from under 1% to well over 50% with a FWHM of the photoluminescent spectra under 50 nm for some of the preparations.

Kortan and Brus developed a method for creating CdSe coated zinc sulphide (ZnS) nanocrystals and the opposite, zinc sulphide coated cadmium selenide nanocrystals. (Kortan R., Brus L., Nucleation and Growth of CdSe on ZnS Quantum Crystallite Seeds, and Vice Versa, in Inverse Micelle Media, J. Am. Chem. Soc., 112 (1990)). The preparation grew ZnS on CdSe “seeds” using a organometallic precursor-based inverse micelle technique and kept them in solution via an organic capping layer (thiolphenol). The CdSe core nanocrystals had diameters between 3.5 and 4 nm and demonstrated quantum confinement effects including observable exciton absorption peaks and blue shifted photoluminescence. Using another preparation, CdSe cores were coated by a 0.4 nm layer of ZnS. The photoluminescence spectra of the resultant core-shell nanocrystals indicates a peak fluorescence at 530 nm with an approximate 40-45 nm FWHM.

Murray and Bawendi developed an organometallic preparation capable of making CdSe, CdS, and CdTe nanocrystals. (Murray C., Norris D., Bawendi M., Synthesis and Characterization of Nearly Monodisperse CdE (E=S, Se, Te) Semiconductor Nanocrystallites, J. Am. Chem. Soc., 115, (1993)). This work, based on the earlier works of Brus, Henglein, Peyghambarian, allowed for the growth of nanocrystals having a diameter between 1.2 nm and 11.5 nm and with a narrow size distribution (<5%). The synthesis involved a homogeneous nucleation step followed by a growth step. The nucleation step is initiated by the injection of an organometallic cadmium precursor (dimethyl cadmium) with a selenium precursor (TOPSe-trioctylphosphine selenium) into a heated bath containing coordinating ligands (TOPO-trioctylphosphine oxide). The precursors disassociate in the solvent, causing the cadmium and selenium to combine to form a growing nanocrystal. The TOPO coordinates with the nanocrystal to moderate and control the growth. The resultant nanocrystal solution showed an approximate 10% size distribution, however, by titrating the solution with methanol the larger nanocrystals could be selectively precipitated from the solution thereby reducing the overall size distribution. After size selective precipitation, the resultant nanocrystals in solution were nearly monodisperse (capable of reaching a 5% size distribution) but were slightly prolate (i.e. nonspherical having an aspect ratio between 1.1 and 1.3). The photoluminescence spectra show a FWHM of approximately 30-35 nm and a quantum yield of approximately 9.6%.

Katari and Alivisatos slightly modified the Murray preparation to make CdSe nanocrystals. (Katari J., Alivisatos A., X-ray Photoelectron Spectroscopy of CdSe Nanocrystals with Applications to Studies of the Nanocrystal Surface, J. Phys. Chem., 98 (1994)). They found that by substituting the selenium precursor TOPSe with TBPSe (TriButylPhosphineSelenide), nanocrystals were produced that were nearly monodisperse without size selective precipitation, crystalline, and spherical. The nanocrystals were size tunable from 1.8 nm to 6.7 nm in diameter and had an exciton peak position ranging from 1.9-2.5 eV (corresponding to 635-496 nm wavelength). Like the Murray paper, TOPO was used as the coordinating ligand.

Hines and Guyot-Sionest developed a method for synthesizing a ZnS shell around a CdSe core nanocrystal. (Hines et al., “Synthesis and Characterization of strongly Luminescing ZnS capped CdSe Nanocrystals”; J. Phys. Chem., 100:468-471 (1996)). The CdSe cores, having a monodisperse distribution between 2.7 nm and 3.0 nm (i.e. 5% size distribution with average nanocrystal diameter being 2.85 nm), were produced using the Katari and Alivisatos variation of the Murray synthesis. The photoluminescence spectra of the core shows a FWHM of approximately 30 nm with a peak at approximately 540 nm. The core CdSe nanocrystals were separated, purified, and resuspended in a TOPO solvent. The solution was heated and injected with zinc and sulfur precursors (dimethyl zinc and (TMS)₂S) to form a ZnS shell around the CdSe cores. The resultant shells were 0.6.+−0.3 nm thick, corresponding to 1-3 monolayers. The photoluminescence of the core-shell nanocrystals had a peak at 545 nm, FWHM of 40 nm, and a quantum yield of 50%.

Although much work has been done using III-V materials, very little work has been done on I-III-VI semiconductor nanocrystals. Of such work, only weakly fluorescing (<5% quantum yield) nanocrystals have been reported. Castro et al, Chem. Matter (2003), 15(16); 3142-3147 describes the use of a single source precursor to produce CuInS₂ nanocrystals. These nanocrystals aggregated and showed very little fluorescence (Castro, et al., “Synthesis and Characterization of Colloidal CuInS₂ Nanoparticles from a Molecular Single-Source Precursor,” Phys. Chem. B.; 108(33); 12429-12435 (2004)). Subsequent publications disclose soluble particles, however, the particles are very weakly fluorescing (<5% quantum yield). Nakamura et al, describes annealing zinc into CuInS to produce weakly fluorescing 5% quantum yield nanocrystals. Without the presence of the Zn, a quantum yield of <0.1% was reported. Also reported in the Nakamura paper is the use of a mercaptounadecanoinc acid as a ligand to render them water soluble, however due to the low reported quantum yields the materials produced via these methods is not useful for applications where fluorescence is important.

Moreover, one problem associated with known colloidal synthesis methods is that they are limited in regard to the growth of quality I-III-VI nanocrystals due, at least in part, to the fact that the resulting materials are easily oxidized during growth. Another problem associated with the growth of I-III-VI semiconductor nanocrystal complexes is that the resulting material tends to aggregate. Yet another problem associated with the growth of I-III-VI semiconductor nanocrystals is the covalent nature of the material. The reactivity and the amount of materials have to be carefully balanced otherwise the resulting material will not form properly, resulting in a population of particles with multiple phases.

Due in part to the problems mentioned above, difficulties have arisen in growing I-III-VI semiconductor nanocrystal complexes.

Thus, there is a need in the art to develop a stable I-III-IV semiconductor nanocrystal complex that is brightly fluorescing and soluble in most common solvents.

### SUMMARY OF THE INVENTION

In an embodiment, the present invention provides a semiconductor nanocrystal composition comprising a I-III-VI semiconductor nanocrystal core, wherein the semiconductor nanocrystal composition is stable and exhibits a high luminescent quantum yield.

In another embodiment, the present invention provides a water-stable semiconductor nanocrystal complex. The water-stable semiconductor nanocrystal complex comprises a semiconductor nanocrystal composition including a I-III-VI semiconductor nanocrystal core. The water-stable semiconductor nanocrystal complex also includes a surface layer comprising molecules having a moiety with an affinity for the semiconductor nanocrystal composition and a moiety with an affinity for a hydrophobic solvent. The water-stable semiconductor nanocrystal complex further comprises a water-stabilizing layer having a hydrophobic end for interacting with the surface layer and a hydrophilic end for interacting with an aqueous medium. Other methods of stabilizing nanocrystals in water can be utilized in preparing I-III-VI semiconductor nanocrystal complexes.

In still another embodiment, the present invention provides a method of making a semiconductor nanocrystal complex comprising synthesizing a semiconductor nanocrystal core comprising a I-III-VI semiconductor nanocrystal core, wherein the semiconductor nanocrystal complex is stable and exhibits a high luminescent quantum yield.

In yet another embodiment, the present invention provides a method of making a water stable semiconductor nanocrystal complex comprising synthesizing a semiconductor nanocrystal composition comprising a semiconductor nanocrystal core comprising a I-III-VI semiconductor nanocrystal material. The method further comprises forming a surface layer either directly or indirectly on the semiconductor nanocrystal core, and forming a water-stabilizing layer on the surface layer. The water-stabilizing layer has a hydrophobic end for interacting with the surface layer and a hydrophilic end for interacting with an aqueous medium.

### BRIEF DESCRIPTION OF THE DRAWINGS

FIG. 1 is a schematic illustration of a semiconductor nanocrystal complex according to an embodiment of the present invention.

FIG. 2 is a schematic illustration of a semiconductor nanocrystal complex according to another embodiment of the present invention.

FIG. 3 is a schematic illustration of a semiconductor nanocrystal complex according to still another embodiment of the present invention.

FIG. 4 is a schematic illustration of a semiconductor nanocrystal complex according to yet another embodiment of the present invention.

FIG. 5 is a schematic illustration of a water-stable semiconductor nanocrystal complex according to an embodiment of the present invention.

FIG. 6 is an exemplary conjugation method to conjugate tertiary molecules to a water-stable semiconductor nanocrystal complex of the present invention.

FIG. 7 is a flow chart illustrating a method of making a semiconductor nanocrystal complex according to an embodiment of the present invention.

FIG. 8 is a flow chart illustrating a method of making a water-stable semiconductor nanocrystal complex according to an embodiment of the present invention.

FIG. 9 is a graph that represents the absorption wavelengths for a semiconductor nanocrystal manufactured according to a method of the present invention.

FIG. 10 depicts the emission wavelength of a semiconductor nanocrystal complex manufactured according to a method of the present invention.

FIG. 11 depicts the absorption spectrum of a CuInGaSe₂ semiconductor nanocrystal shelled with ZnS manufactured according to a method of the present invention.

### DETAILED DESCRIPTION OF THE INVENTION

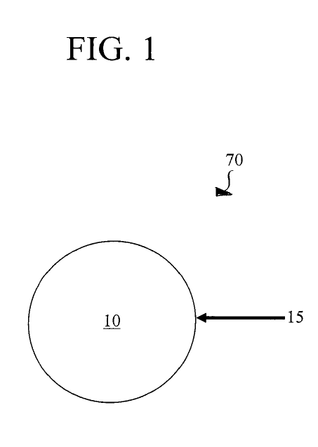

The present invention provides semiconductor nanocrystals, including water-stable semiconductor nanocrystals. Referring to FIG. 1, in an embodiment, the present invention provides a semiconductor nanocrystal composition 70 comprising a semiconductor nanocrystal core 10 (also known as a semiconductor nanoparticle or semiconductor quantum dot) having an outer surface 15. Semiconductor nanocrystal core 10 may be spherical nanoscale crystalline materials (although oblate and oblique spheroids can be grown as well as rods and other shapes) having a diameter of less than the Bohr radius for a given material and typically but not exclusively comprises I-III-VI ternary semiconductors. Non-limiting examples of semiconductor materials that semiconductor nanocrystal core 10 can comprise include CuInGaS₂, CuInGASe₂, AgInS₂, AgInSe₂, and AuGaTe₂ (I-III-VI materials). In a preferred embodiment, semiconductor nanocrystal core 10 comprises I-III-VI semiconductor nanocrystal materials. In addition to ternary semiconductors, semiconductor nanocrystal core 10 may comprise quaternary or quintary semiconductor materials. Non-limiting examples of semiconductor materials include AₓB_{y}C_{z}D_{w}E₂ᵥ wherein A and/or B may comprise a group I and/or VII element, and C and D may comprise a group III, II and/or V element although C and D cannot both be group V elements, and E may comprise a VI element, and x, y, z, w, and v are molar fractions between 0 and 1.

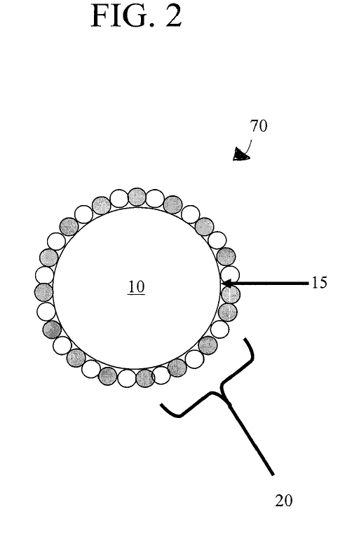

Referring to FIG. 2, in an alternate embodiment, one or more metals 20 are formed on outer surface 15 of semiconductor nanocrystal core 10 (referred to herein as “metal layer” 20) after formation of core 10. Metal layer 20 may act to passivate outer surface 15 of semiconductor nanocrystal core 10 and limit the diffusion rate of oxygen molecules to semiconductor nanocrystal core 10. According to the present invention, metal layer 20 is formed on outer surface 15 after synthesis of semiconductor nanocrystal core 10 (as opposed to being formed on outer surface 15 concurrently during synthesis of semiconductor nanocrystal core 10). Metal layer 20 may include any number, type, combination, and arrangement of metals. For example, metal layer 20 may be simply a monolayer of metals formed on outer surface 15 or multiple layers of metals formed on outer surface 15. Metal layer 20 may also include different types of metals arranged, for example, in alternating fashion. Further, metal layer 20 may encapsulate semiconductor nanocrystal core 10 as shown in FIG. 2 or may be formed on only parts of outer surface 15 of semiconductor nanocrystal core 10. Metal layer 20 may include the metal from which the semiconductor nanocrystal core is made either alone or in addition to another metal. Non-limiting examples of metals that may be used as part of metal layer 20 include Cd, Zn, Hg, Pb, Al, Ga, or In.

Semiconductor nanocrystal composition 70, according to the present invention, is electronically and chemically stable with a high luminescent quantum yield. Chemical stability refers to the ability of a semiconductor nanocrystal composition to resist fluorescence quenching over time in aqueous and ambient conditions. Preferably, the semiconductor nanocrystal compositions resist fluorescence quenching for at least a week, more preferably for at least a month, even more preferably for at least six months, and even more preferably for at least a year. Electronic stability refers to whether the addition of electron or hole withdrawing ligands substantially quenches the fluorescence of the semiconductor nanocrystal composition. Preferably, a semiconductor nanocrystal composition would also be colloidally stable in that when suspended in organic or aqueous media (depending on the ligands) they remain soluble over time. Preferably, a high luminescent quantum yield refers to a quantum yield of at least 10%. Quantum yield may be measured by comparison to Rhodamine 6G dye with a 488 excitation source. Preferably, the quantum yield of the semiconductor nanocrystal composition is at least 25%, preferably at least 30%, more preferably at least 45%, even more preferably at least 55%, and even more preferably at least 60%, including all intermediate values therebetween, as measured under ambient conditions. The semiconductor nanocrystal compositions of the present invention experience little loss of fluorescence over time and can be manipulated to be soluble in organic and inorganic solvents as traditional semiconductor nanocrystals.

Semiconductor nanocrystal core 10 and metal layer 20 may be grown by the pyrolysis of organometallic precursors in a chelating ligand solution or by an exchange reaction using the prerequisite salts in a chelating ligand solution. The chelating ligands are typically lyophilic and have an affinity moiety for the metal layer and another moiety with an affinity toward the solvent, which is usually hydrophobic. Typical examples of chelating ligands include lyophilic surfactant molecules such as Trioctylphosphine oxide (TOPO), Trioctylphosphine (TOP), Tributylphosphine (TBP), Hexadecylamine (HAD), Dodecanethiol, and Tetradecyl phosphonic acid (TDPA).

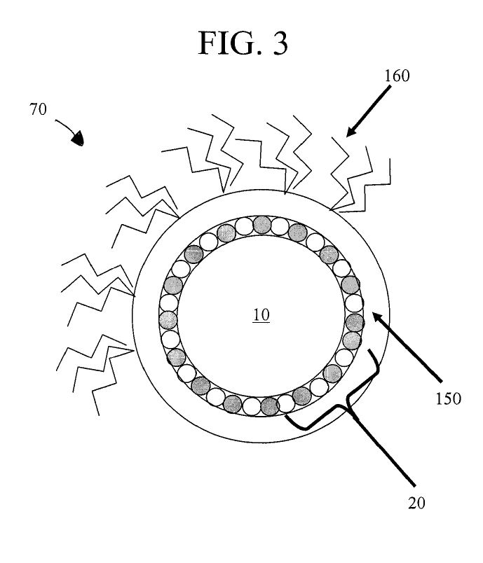

Referring to FIG. 3, in an alternate embodiment, the present invention provides a nanocrystal composition 70 further comprising a shell 150 overcoating metal layer 20. Shell 150 may comprise a semiconductor material having a bulk bandgap greater than that of semiconductor nanocrystal core 10. In such an embodiment, metal layer 20 may act to passivate outer surface 15 of semiconductor nanocrystal core 10 as well as to prevent or decrease lattice mismatch between semiconductor nanocrystal core 10 and shell 150.

Shell 150 may be grown around metal layer 20 and is typically, although not always, between 0.1 nm and 10 nm thick. Shell 150 may provide for a type A semiconductor nanocrystal composition 70. Shell 150 may comprise various different semiconductor materials such as, for example, CdSe, CdS, CdTe, ZnS, ZnSe, ZnTe, HgS, HgSe, HgTe, InP, InAs, InSb, InN, GaN, GaP, GaAs, GaSb, PbSe, PbS, PbTe, CuInGaS₂, CuInGaSe₂, AgInS₂, AgInSe₂, AuGaTe₂, ZnCuInS₂. The presence of metal layer 20 may provide for a more complete and uniform shell 150 without the amount of defects that would be present with a greater lattice mismatch. Such a result may improve the quantum yield of resulting nanocrystal composition 70.

Semiconductor nanocrystal core 10, metal layer 20, and shell 150 may be grown by the pyrolysis of organometallic precursors in a chelating ligand solution or by an exchange reaction using the prerequisite salts in a chelating ligand solution. The chelating ligands are typically lyophilic and have an affinity moiety for the shell and another moiety with an affinity toward the solvent, which is usually hydrophobic. Typical examples of chelating ligands 160 include lyophilic surfactant molecules such as Trioctylphosphine oxide (TOPO), Trioctylphosphine (TOP), Tributylphosphine (TBP), and Hexadecyl amine (HDA).

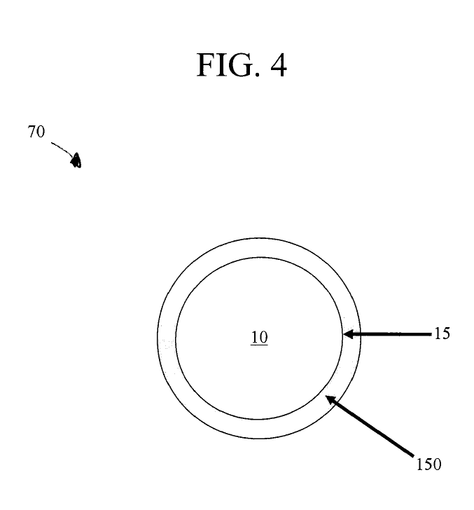

Referring to FIG. 4, in another alternate embodiment, the present invention provides a semiconductor nanocrystal complex 70 comprising a semiconductor nanocrystal core 10 having an outer surface 15, as described above, and a shell 150, as described above, formed on the outer surface 15 of the core 10. The shell 150 may encapsulate semiconductor nanocrystal core 10 as shown in FIG. 4 or may be formed on only part of outer surface 15 of semiconductor nanocrystal core 10.

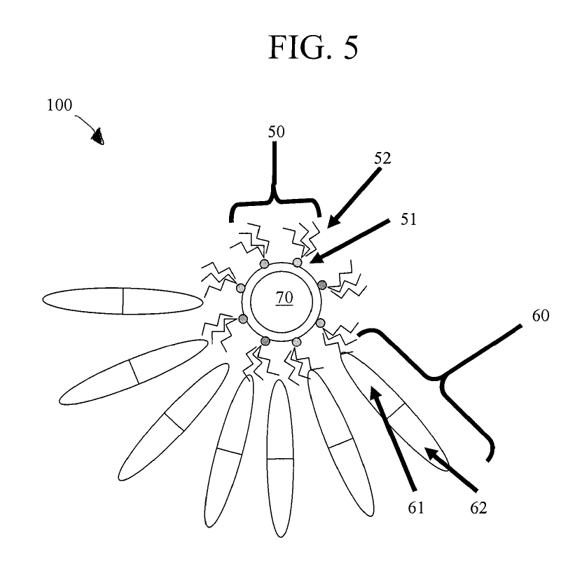

Referring to FIG. 5, the present invention also provides a water-stable semiconductor nanocrystal complex 100 comprising a semiconductor nanocrystal composition described above and further comprising a surface layer 50 that coats the semiconductor nanocrystal composition. Surface layer 50 generally comprises surface organic molecules that have a moiety 51 with an affinity for semiconductor nanocrystal composition 70 and another moiety 52 with an affinity for a hydrophobic solvent. Non-limiting examples of moieties that have an affinity for a nanocrystal surface include thiols, amines, phosphines, and phosphine oxides. Non-limiting examples of surface molecules comprising surface layer 50 include trioctyl phosphine oxide (TOPO), trioctyl phosphine (TOP), tributyl phosphine (TBP), dodecyl amine, octadecyl amine, hexadecylamine, stearic acid, oleic acid, palmitic acid, lauric acid, and combinations thereof. Such surface molecules are typically used in the synthesis of semiconductor nanocrystal compositions and can remain on the surface of the nanocrystals after synthesis or may be replaced by other surfactants after synthesis. As is generally known to one of skill in the art, semiconductor nanocrystals according to the present invention may be coated with a surface layer by pyrolysis of organometallic precursors in a chelating ligand solution or by an exchange reaction using the prerequisite salts in a chelating surface solution, such chelating surfaces typically being lyophilic.

Referring still to FIG. 5, a water-stable semiconductor nanocrystal complex of the present invention further comprises a water-stabilizing layer 60. Water stabilizing layer 60 preferably comprises lipids or polymer-based molecules including a hydrophilic end section 62 and a hydrophobic end section 61. The hydrophobic end section of a water-stabilizing layer has an affinity for a surface layer present on the surface of a semiconductor nanocrystal composition.

In an embodiment, a water-stabilizing layer comprises diblock polymers that surround the semiconductor nanocrystal composition to form a micelle. More than one surface-coated semiconductor nanocrystal composition of the present invention may be surrounded by a diblock polymer coating. A diblock polymer is generally but not exclusively a linear chain that has a hydrophobic end comprising hydrophobic functional groups that is covalently bonded to a hydrophilic end comprising hydrophilic functional groups. In an aqueous medium, a diblock polymer coating assembles around a surface-coated semiconductor nanocrystal composition of the present invention. Specifically, the hydrophobic end of a diblock polymer is attracted to the surface-coated nanocrystal composition and interacts with the moiety of the surface layer that has an affinity for a hydrophobic solvent through noncovalent interactions such as, for example, hydrogen bonding, Van der Waals Forces, and hydrophobic interactions. The hydrophilic end of a diblock polymer, in turn, is directed to the aqueous medium.

With respect to the lengths of the hydrophobic and hydrophilic end of a diblock polymer, each end has lengths greater than 1 and preferably each have lengths between 1 and 1000. In a more preferred embodiment, the hydrophobic end of a diblock polymer has between 60 and 180 carbon atoms. In a more preferred embodiment, the hydrophobic end has about 150 carbon atoms and the hydrophilic end has about 220-240 carbon atoms. Also in a preferred embodiment, the hydrophobic end has about 10-20 monomer units and the hydrophilic end has about 110-120 monomer units. Although the hydrophilic end and the hydrophobic end may have different lengths, in a preferred embodiment, they are substantially equal in length.

The hydrophobic functional groups of the hydrophobic end of a diblock polymer that can be used as a water-stabilizing layer are preferably groups of covalently bonded atoms on a larger molecule that are nonpolar and not ionizable and therefore have an affinity for nonpolar and non-ionizable solvents. Non-limiting examples of hydrophobic functional groups according to the present invention include hydrocarbons of various lengths. The hydrophilic functional groups of the hydrophilic end are preferably groups of atoms on a larger molecule that are highly polar or ionizable and therefore have an affinity for water and other polar solvents. Non-limiting examples of hydrophilic functional groups include hydroxy, amine, carboxyl, sulfonates, phosphates, amines, nitrates, and combinations thereof.

Non-limiting examples of diblock polymers that comprise a diblock polymer coating surrounding a surface-coated semiconductor nanocrystal composition according to an embodiment of the present invention include poly(acrylic acid-b-methyl methacrylate), poly(methyl methacrylate-b-sodium acrylate), poly(t-butyl methacrylate-b-ethylene oxide), poly(methyl methacrylate-b-sodium methacrylate), poly (methyl methacrylate-b-N-methyl 1-4-vinyl pyridinium iodide), poly(methyl methacrylate-b-N,N-dimethyl acrylamide), poly(butadiene-b-methacrylate acid and sodium salt), poly(butadiene(1,2 addition)-b-acrylic acid), poly(butadiene(1,2 addition)-b-sodium acrylate), poly(butadiene(1,4 addition)-b-acrylic acid), poly(butadiene(1,4 addition)-b-sodium acrylate), poly(butadiene(1,4 addition)-b-ethylene oxide), poly(butadiene(1,2 addition)-b-ethylene oxide), poly(styrene-b-acrylic acid), poly(styrene-b-acrylamide), poly(styrene-b-cesium acrylate), poly(styrene-b-sodium acrylate), poly(styrene-b-ethylene oxide), poly(styrene-b-methacrylic acid), poly(styrene-b-sodium methacrylate), and combinations thereof.

In order to form a cohesive coating around a surface-coated semiconductor nanocrystal composition of the present invention, adjacent diblock polymers of a diblock polymer coating are preferably linked together by bridging molecules. Preferably, the bridging molecules are multidentate bridging molecules having one or more reactive functional groups that can react with and bond to one or more hydrophilic functional groups of the hydrophilic end thereby crosslinking adjacent diblock polymers together. Therefore, the self-assembled diblock polymer coating is knit together to form a cohesive coating around a surface-coated semiconductor nanocrystal composition of the present invention that will not dissociate in water over long periods. The multidentate bridging molecule may have one or more than one type of reactive functional group. Non-limiting examples of such reactive functional groups include hydroxy (OH), carboxylate (COOH), amine (NH₂) groups, and combinations thereof. In a preferred embodiment, a bridging molecule is diamine, 2,2′-(ethylenedioxy)bis(ethylamine) and the amine functional groups on the diamine react with hydrophilic functional groups that are carboxylate groups on a hydrophilic end of a diblock polymer to form a stable peptide bond.

In another embodiment, the water-stabilizing layer is a layer of PEGylated phospholipids. In a preferred embodiment, the hydrophobic end of the PEGylated phospholipid comprises fatty acyl groups in a phospholipid such as 1,2-di(fatty acyl)-sn-glycero-3-phosphoethanolamine and the hydrophilic end is polyethylene glycol. Other examples of fatty acid chains that comprise the phospholipids include those chains that have triple bonds other cross linkable moieties, which when exposed to the appropriate UV light, chemical agents will forma a covalent bond with fatty acid chains located on adjacent phospholipids, thus forming a more stable and cohesive coating.

The performance of semiconductor nanocrystal complexes of the present invention as dependable biological research tools is related to their ability to withstand the stringent conditions found in most cellular contexts. Oxidative stress, changes in salt concentration, pH, and temperature, as well as proteolytic susceptibility are some examples of the conditions these nanocrystals need to withstand in order to be useful in aqueous biological assays.

In addition to providing a layer of water stability to a semiconductor nanocrystal composition, a water-stabilizing layer can also provide surface exposed functional groups to facilitate the conjugation of ligands or tertiary molecules for target specific applications. This is the layer of the semiconductor nanocrystal complex that opens opportunity for the biologist to exploit an entire host of molecular interactions. For example, the semiconductor nanocrystal surfaces can be tagged with a bio-recognition molecule (e.g., antibody, peptide, small molecule drug or nucleic acid) designed to target only the molecular signature of interest (e.g., cell surface receptor proteins, viral DNA sequences, disease antigens.) The interaction of the tagged semiconductor nanocrystal with its target could then be visualized with the appropriate fluorescence detection and imaging equipment.

Functional groups exposed on the surface of a water-stable semiconductor nanocrystal complex can be coupled to polynucleic acids, aptamers, proteins, peptides, enzymes, antibodies, small molecules and molecular recognition molecules. These complexes may serve as the basis for many types of in vitro, in vivo, or chemical/biological detection assays. Some examples of applicable assays include, DNA/RNA assays and microarrays; high throughput screens; whole blood and tissue screening in medical diagnostics; immunoassays, dot blots and other membrane-based detection technologies. Functional groups include but are not limited to alcohol (OH), carboxylate (COOH), and amine (NH₂), hydroxy, carboxyl, sulfonates, phosphates, nitrates, and combinations thereof. More than one type of functional group may be present on the surface of the water-stabilizing layer. In addition to comprising functional groups on its surface, a water-stable semiconductor nanocrystal complex may comprise one or more tertiary molecules.

The term tertiary molecule refers to any molecule that can be coupled to the water-stable semiconductor nanocrystal complex. The coupling of tertiary molecules to a water-stable semiconductor nanocrystal complex is achieved by reacting functional groups present on the tertiary molecule with hydrophilic functional groups present on the water-stabilizing layer of a water-stable semiconductor nanocrystal complex. Tertiary molecules include members of specific binding pairs such as, for example, an antibody, antigen, hapten, antihapten, biotin, avidin, streptavidin, IgG, protein A, protein G, drug receptor, drug, toxin receptor, toxin, carbohydrate, lectin, peptide receptor, peptide, protein receptor, protein, carbohydrate receptor, carbohydrate, polynucleotide binding protein, polynucleotide, DNA, RNA, ADNA, ARNA, enzyme, substrate, and combinations thereof. Other non-limiting examples of tertiary molecules include a polypeptide, glycopeptide, peptide nucleic acid, oligonucleotide, aptamer, cellular receptor molecule, enzyme cofactor, oligosaccharide, a liposaccharide, a glycolipid, a polymer, a metallic surface, a metallic particle, an organic dye molecule, and combinations thereof. Depending on the material used for the water-stabilizing layer, the tertiary molecule may be part of the water-stabilizing layer. For example, in the event that the water-stabilizing layer comprises a biotin terminated lipid, then the tertiary molecule (the biotin) would be a part of the water-stabilizing layer. One or more of the same or different tertiary molecules can be coupled to a water-stable semiconductor nanocrystal complex of the present invention.

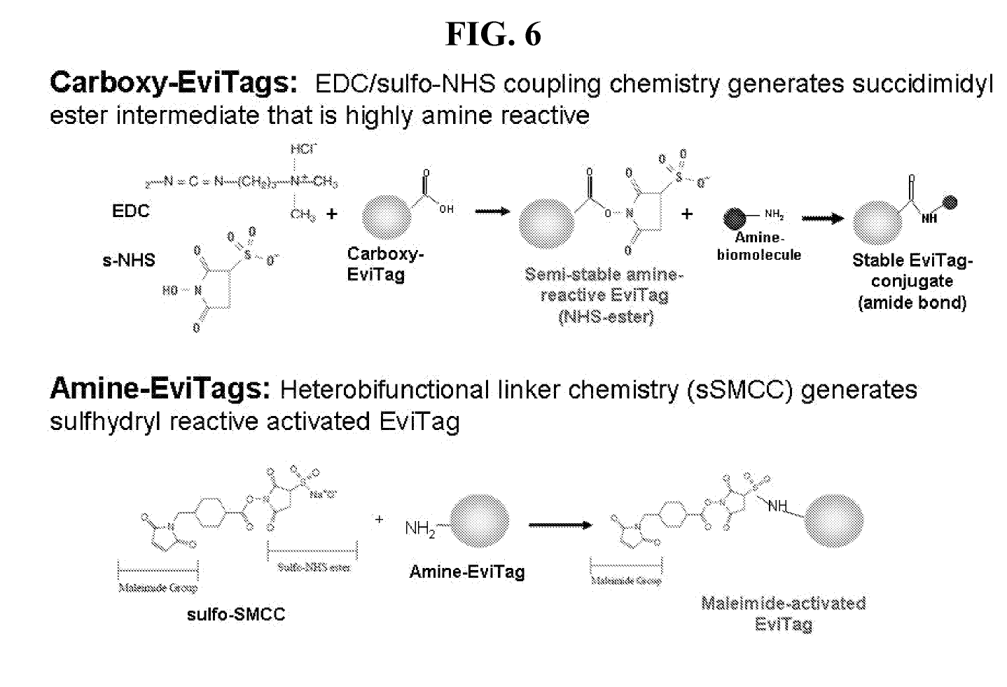

An exemplary conjugation method to conjugate tertiary molecules to the functional groups of a water-stabilizing layer of a water-stable semiconductor nanocrystal complex is illustrated in FIG. 6. Using this protocol, many semiconductor nanocrystals complexes that possess functional moieties suitable for conjugation to biomolecules can be prepared. The functional groups to be employed include, but are not limited to, carboxylic acids, amines, sulfhydryls, maleimides, and combinations thereof. Established protein or nucleic acid conjugation protocols can then be used to generate customized ligand-bound semiconductor nanocrystals in a straightforward manner. The method depicted in FIG. 6, uses EDC (1-ethyl-3(3-dimethylaminopropyl)carbodimide HCl) and sulfo-NHS(N-hydrocylsulfo-succinimide) to form active esters on the surface of the semiconductor nanocrystal complex. Once the unreacted EDC and sulfo-NHS are removed, a protein of interest may be added and efficiently conjugated to a water-stable semiconductor nanocrystal complex.

The present invention also provides a substantially monodisperse population of semiconductor nanocrystal compositions, each composition comprising a semiconductor nanocrystal core comprising a I-III-VI semiconductor material, wherein the semiconductor nanocrystal complex is stable with a high luminescent quantum yield. The population of semiconductor nanocrystal complexes should be substantially homogenous with respect to the phase of the nanocrystals. The phase of a population of nanocrystal can be determined through the use of Powder X-Ray diffraction. The present invention also provides for a substantially monodisperse population of water-stable semiconductor nanocrystal complexes, each complex comprising a semiconductor nanocrystal composition comprising a semiconductor nanocrystal core comprising a I-III-VI semiconductor material.

The semiconductor nanocrystal complexes of the present invention may be grown such that the particles are quantum confined. The core semiconductor nanocrystals may preferably be grown such that the particles are less than 20 nm in diameter. More preferably, the semiconductor nanocrystals may be grown such that that diameters are less than 15 nm. More preferably, the diameter of the core semiconductor nanocrystals may be less than 10 nm.

Due to the ability to control the size of the particles, the present invention encompasses semiconductor nanocrystal complexes that emit light in the near infrared region (greater than 700 nm). This wavelength region has proven to be difficult to efficiently reach with traditional semiconductor nanocrystal complexes.

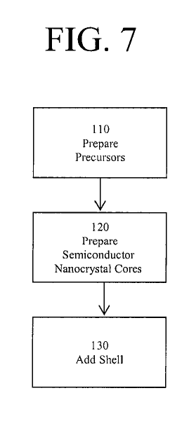

FIG. 7 provides an exemplary method of making a semiconductor nanocrystal composition of the present invention. Although the exemplary method will be described with respect to the preparation of a CuInGaS₂ semiconductor nanocrystal core with an optional ZnS shell, it will be appreciated that other types and combinations of semiconductor cores, metal layers and/or semiconductor shells may be used to manufacture a nanocrystal complex of the present invention. Further, additional layers can be added to the semiconductor nanocrystal complex.

In step 110, the required copper, indium, gallium, and sulfur precursors are prepared. A precursor is often needed for the Group I material, for example Cu, Ag, or Au. These materials may be purchased from various chemical supply companies. Non-limiting examples of compositions that may be used as a precursor for the preparation of a Group I material in the semiconductor nanocrystal complexes of the present invention include Cu(I) thiolate, Cu(I) acetate, Cu(II) acetate, Ag corbamates, Au thiols, Au acetates, and combinations thereof. In a preferred embodiment, copper thiolate is used as a precursor for the manufacture of a I-III-VI semiconductor nanocrystal core comprising copper. In the event Cu(I) acetate is used as a copper precursor, the copper acetate may first be heated with a dodecanethiol to form a copper thiolate complex prior to the preparation of the I-III-VI semiconductor nanocrystal core. The copper thiolate precursor may be generated from a combination of copper acetate and dodecanethiol at temperatures of approximately 100° C. Indium and gallium precursors can be made by mixing indium acetate and gallium acetylacetonate and palmitic acid, where the molar ratio between indium and gallium is, for example, 1:1 to 20:1, and preferably 9:1, while the ratio of palmitic acid to the sum of gallium and indium is approximately 3:1. The solution can then be heated to approximately 130° C. to form indium gallium palmitic precursor. Gallium acetate and indium acetylacetonate may also be used. The sulfur precursor can be derived from elemental sulfur dissolved in oleyamine at room temperature and pressure.

In step 120, the semiconductor nanocrystal cores are prepared. A specific procedure for growing a core semiconductor nanocrystal comprising a I-III-VI semiconductor material is described in the Example 1 below. Although, the procedure is described with respect to the preparation of CuInGaS₂ and CuInGaSe₂ cores, which are quaternary semiconductors, a ternary semiconductor material may be grown using a single material from group III. One method of preparing a semiconductor nanocrystal core involves synthesizing CuInGaS₂ in a coordinating solvent. In certain embodiments, all gallium, indium, and copper precursors are mixed in a non-coordinating solvent (for example, ‘ODE’, 1-octadecene) at room temperature and approximately room pressure and the solution is heated between approximately 130° C. and 280° C., preferably 150° C. Once the solution has reached a particular reaction temperature (such as 150° C., for example), the (TMS)₂S in TOP precursor can be quickly injected into the reaction vessel and the nanocrystals begin to form (preferably the reaction mixture is held at 200° C. throughout the reaction period). The reaction period can determine the size of the resulting nanocrystals such that the longer the reaction period, the larger the ensuing nanocrystals. Once the nanocrystal cores have reached the desired size, the reaction can be stopped by quickly cooling to temperatures below 70° C., for example, by adding a cold solvent into the reaction vessel, immersing the reaction vessel in a cold bath, blowing cool gas onto the reaction vessel, or combinations thereof. In certain embodiments, once the nanocrystal cores are synthesized, the surface of the core nanocrystal is made “metal rich” (for example, a ˜monolayer of zinc is added to the nanocrystal core). This “metal layer” can improve the quality of the subsequent semiconductor shelling step resulting in brighter and more stable quantum dots. One non-limiting process for metal coating the semiconductor nanocrystal core or rather creating a metal rich surface is as follows: zinc oleate is once again added to the reaction mixture (which now contain the nanocrystal cores) and the reaction mixture is then heated to 180° C. for greater than 20 minutes at room pressure. After the “metal layer” is added, the reaction mixture is cooled to room temperature.

In order to isolate the semiconductor nanocrystals cores from a non-coordinating solvent, pure acetone or a mixture of methanol, butanol, and toluene (for example, a 2:1:1 ratio of methanol, butanol, and toluene) may be added to the solution at temperatures ranging from room temperature to 100° C. until the mixture becomes visibly turbid. Because the semiconductor nanocrystal cores have a hydrophobic oleylamine/dodecanethiol surfactant layer on the surface, they are insoluble in acetone or a mixture of methanol, butanol, and toluene, which facilitates the nanocrystal separation from the reaction mixture. The toluene added to the methanol and butanol keeps residual unreacted precursors solvated. The “metal coated” nanocrystal cores are then separated from the reaction mixture by sedimentation/flocculation (via centrifuge). Washing the semiconductor nanocrystal cores in methanol and toluene results in semiconductor nanocrystals cores precipitating out of solution.

In step 130, a shell may be added to the semiconductor nanocrystal core. To form the shell, two precursor solutions can be added to the solution of the semiconductor nanocrystal core. Preferably, the precursors can be added at a temperature range between about 130° C. to 250° C., and more preferably 180° C. The pressure may be slightly positive due to nitrogen overpressure. The first solution can be a metal precursor in a ligand, the second solution can be (TMS)₂S in TOP. Enough of the solutions is added to allow ZnS to shell the surface of the semiconductor nanocrystal core. For example, enough may be added to provide 1-8 shells on the core.

An alternative to shelling the semiconductor nanocrystal that can result in an outer coating of a desired semiconductor material is through the addition of a metal layer and then the addition of a chalcagonide, pnictide or a non-metal anion layer and the addition of a second metal layer. Treating a semiconductor nanocrystal composition with an anion and then adding a second metal layer can stabilize the luminescent properties of the resulting composition. Additionally, treating the composition with an anion and an additional metal layer can create a resulting composition that can be stably added to a variety of solvents including water and other organic and inorganic solvents with little or no loss of fluorescence using standard nanocrystal chemistries. The procedure for adding the non-metal anion layer and the second metal layer is described below in detail.

The anion layer may be a layer of one or more anionic elements and does not include metallic compounds. Anion layer may include any number, type, combination, and arrangement of anions. For example, anion layer may be simply a monolayer of anions added to the metal layer. Non-limiting examples of elements that may comprise the anion layer include group IV, V, and VI elements. Preferably the temperature at which the anions may be attached is between about room temperature to 120° C.

Once the nanocrystal synthesis is complete, the desired nanocrystal compositions are precipitated out of solution. Preferably, the compositions are precipitated out of solution at a temperature between about room temperature and 120° C.

All the above described steps may take place under nitrogen, which can improve the quantum yield of the resulting nanocrystal composition. The resulting nanocrystal compositions can be more resistant to oxidation and have an increased quantum yield over semiconductor nanocrystals of I-III-VI made by known techniques. The nanocrystals resulting from step 130 may be size separated. Size separating the nanocrystal yields solutions with crystals that are more monodisperse and retain the quantum yield.

The above-described technique is only exemplary and other modifications may be made that result in semiconductor nanocrystal compositions according to the present invention.

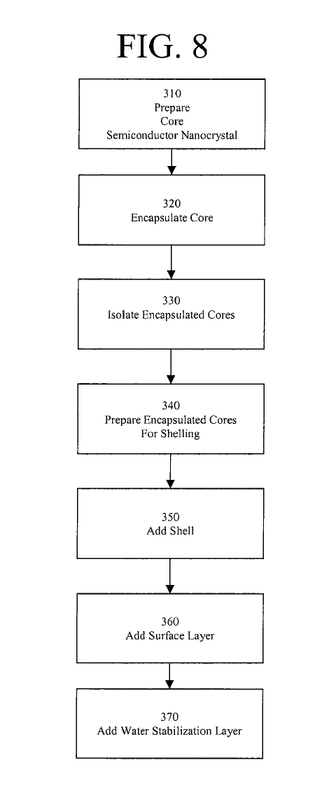

FIG. 8 provides an exemplary method of making a water-stable nanocrystal complex of the present invention. Although the exemplary method will be described with respect to the preparation of a CuInGaS₂ semiconductor nanocrystal core, and a ZnS shell, it will be appreciated that other types and combinations of semiconductor cores, metal layers, and semiconductor shells may be used to manufacture a nanocrystal complex of the present invention. Further, additional layers can be added to the semiconductor nanocrystal complex.

In step 310, a semiconductor nanocrystal core is prepared. There are numerous ways to prepare semiconductor nanocrystal cores some of which have been described above. The specific procedure for growing a core semiconductor nanocrystal comprising a I-III-VI semiconductor material is described below. Although, the procedure is described with respect to the preparation of an CuInGaS₂ and CuInGaSe₂, or ZnCuInGaS₂ core, other ternary semiconductor materials may be grown using the teachings of the procedures. Similarly, other quaternary or quintary semiconductor materials may be grown using the teachings of the procedure. One method of preparing a semiconductor nanocrystal core involves CuInGaS₂ in a coordinating solution. In certain embodiments, all Zn, Ga, In, and Cu precursors are mixed in a non-coordinating solvent (for example, ‘ODE’, 1-octadecene) at room temperature and approximately room pressure and the solution is heated between approximately 150° C. and 280° C., preferably 180° C. Once the solution has reached a particular reaction temperature (such as 180° C., for example), the sulfur oleylamine precursor can be quickly injected into the reaction vessel and the nanocrystals begin to form (preferably the reaction mixture is held at 180° C. throughout the reaction period). The reaction period can determine the size of the resulting nanocrystals such that the longer the reaction period the larger the ensuing nanocrystals. Once the nanocrystal cores have reached the desired size, the reaction can be stopped by quickly cooling to temperatures below 70° C., for example, by adding a cold solvent into the reaction vessel, immersing the reaction vessel in a cold bath, blowing cool gas onto the reaction vessel, or combinations thereof.

In step 320, a metal layer is added to the semiconductor nanocrystal core to encapsulate the semiconductor nanocrystal core (or to otherwise form a metal layer on the outer surface of the semiconductor nanocrystal core) and make the surface of the core nanocrystal “metal rich” (for example, a ˜monolayer of zinc is added to the nanocrystal core). This “metal layer” can improve the quality of the subsequent semiconductor shelling step resulting in brighter and more stable quantum dots. Once the solution of a metal precursor(s) is prepared, it is added to the semiconductor nanocrystal core solution at room temperature resulting in a solution of semiconductor nanocrystal cores, purified solvent, and metal precursor. Non-limiting examples of metal precursors that may be used to form a zinc metal layer, for example, include zinc oleate, diethylzinc, zinc acetate, zinc oxalate, zinc stearate, zinc oxide, and combinations thereof. One non-limiting example for metal coating the semiconductor nanocrystal core is as follows: zinc oleate is once again added to the reaction mixture (which now contain the nanocrystal cores) and the reaction mixture is then heated to 180° C. for greater than 20 minutes at room pressure. After the “metal layer” is added, the reaction mixture is cooled to room temperature.

In the procedure described below, a microwave synthesis machine is used for the reaction. It should be appreciated that in the event that traditional heating methods are used for the reaction, the amount of time necessary to form the metal layer as well as the temperature at which the reaction best occurs may vary. The resulting mixture includes semiconductor nanocrystal cores with a metal layer and the ligands used to prepare the reaction.

In step 330, the semiconductor nanocrystal cores with the metal layer are isolated. To isolate the semiconductor nanocrystals cores from a non-coordinating solvent, pure acetone or a mixture of methanol, butanol, and toluene (for example, a 2:1:1 ratio of methanol, butanol, and toluene) may be added to the solution at temperatures ranging from room temperature to 100° C. until the mixture becomes visibly turbid. Because the semiconductor nanocrystal cores have a hydrophobic oleylamine/dodecanethiol surfactant layer on the surface, they are insoluble in acetone or a mixture of methanol, butanol, and toluene, which facilitates the nanocrystal separation from the reaction mixture. The toluene added to the methanol and butanol keeps residual unreacted precursors solvated. The “metal coated” nanocrystal cores are then separated from the reaction mixture by sedimentation/flocculation (via centrifuge). Washing the semiconductor nanocrystal cores in methanol and toluene results in a semiconductor nanocrystal composition comprising a semiconductor nanocrystal core having an outer surface and a metal layer attached to the outer surface.

Alternatively, once the compositions comprising the semiconductor nanocrystal core and the metal layer are drawn out of the solution, a shell can be added using known shelling techniques. Such an alternative embodiment involves step 340—preparing the semiconductor nanocrystal core with metal layer formed thereon for shelling. In one exemplary embodiment, ZnS is grown on the core semiconductor nanocrystal with a metal layer. Initially, the isolated nanocrystal core of the I-III-VI semiconductor nanocrystal material and the metal layer can be dispersed in toluene and the resulting solution can be introduced into a solution containing a ligand. Preferably, the solution can be introduced at a temperature range from between about 130° C. to 250° C., preferably 180° C. The ligand can be, for example, technical grade TOPO or TOP that has been purified using the technique described in step 320. The toluene can then be removed leaving a solution of the I-III-VI core nanocrystals with a metal layer of Zn.

In step 350, the shell is added to the semiconductor nanocrystal core having a metal layer thereon. To form the shell, two precursor solutions can be added to the solution of the semiconductor nanocrystal core with metal layer thereon. Preferably, the precursors can be added at a temperature range between about 130° C. to 250° C., and more preferably 180° C. The first solution can be a metal precursor in a ligand, the second solution can be (TMS)₂S in TOP. Enough of the solutions is added to allow ZnS to shell the surface of the semiconductor nanocrystal core with a metal layer thereon. For example, enough may be added to provide 1-8 shells on the core.

An alternative to shelling the semiconductor nanocrystal that can result in an outer coating of a desired semiconductor material is through the addition of a chalcagonide, pnictide or a non-metal anion layer and the addition of a second metal layer. Treating a semiconductor nanocrystal with an anion and then adding a second metal layer can stabilize the luminescent properties of the resulting composition. Additionally, treating the nanocrystal with an anion and an additional metal layer can create a resulting composition that can be stably added to a variety of solvents including water and other organic and inorganic solvents with little or no loss of fluorescence using standard nanocrystal chemistries. The procedure for adding the non-metal anion layer and the second metal layer is described below in detail.

The anion layer may include any number, type, combination, and arrangement of anions. For example, the anion layer may be simply a monolayer of anions added to the metal layer. Non-limiting examples of elements that may comprise the anion layer include group IV, V, and VI elements. As described below, after the formation of the anion layer, a metal layer may be added to the surface of the anion layer. Preferably, the temperature at which the anions may be attached is between about room temperature and 120° C.

Once the nanocrystal synthesis is complete, the desired nanocrystal compositions can be precipitated out of solution. Preferably, the compositions are precipitated out of solution at a temperature range between about room temperature and 120° C.

All the above described steps may take place under nitrogen, which can improve the quantum yield of the resulting nanocrystal composition. The resulting nanocrystal compositions can be more resistant to oxidation and have an increased quantum yield over semiconductor nanocrystals of I-III-VI made by known techniques. The nanocrystals resulting from step 350 may be size separated. Size separating the nanocrystal yields solutions with crystals that are monodisperse and retain the quantum yield.

In step 360 and step 370, a semiconductor nanocrystal composition is made water-stable through the addition of a surface layer (step 360) and a water-stabilizing layer (step 370). As described above, surface layers are typically organic molecules that have a moiety with an affinity for the surface of the nanocrystals and another moiety with an affinity for a hydrophobic solvent. Lyophilic molecules, such as TOPO (trioctyl phosphine oxide), TOP (trioctyl phosphine), and TBP (tributyl phosphine) are typically used in the synthesis of nanocrystals and can remain on the surface after preparation of the semiconductor nanocrystals or may be added or replaced by other surfactants after synthesis. The surfactants tend to assemble into a coating around the nanocrystal and enable it to suspend in a hydrophobic solvent. Typically, a surface layer of organic molecules will be present on the surface of the nanocrystal after the completion of step 350. However, in the event that a different surface molecule is desired, exchange reactions may be done to alter the surface layer.

Water stabilizing layers are generally but not exclusively linear chains and have a hydrophilic end section and a hydrophobic end section. As described above, this layer may comprise lipids or polymer-based molecules with a hydrophilic end section and a hydrophobic end section. Stabilizing the surface for water soluble applications can be achieved by layering a coat of hydrophilic material onto the semiconductor nanocrystal. Preferably, the hydrophilic material to form the water-stabilizing layer may be added to a nanocrystal solution at a temperature of about room temperature and the solution heated to about 75° C. while the layer forms on the nanocrystal. The pressure may be at room pressure. The composition of this material can vary and can be selected based on the application to be used.

The above-described techniques are only exemplary and other modifications may be made that result in semiconductor nanocrystal complexes according to the present invention.

### EXAMPLES

### Example 1

### Preparing a I-III-V Semiconductor Nanocrystal Composition

The present example discloses how to prepare a stable, high luminescent quantum yield semiconductor nanocrystal complex comprising a core of CuInGaS₂. However, the teachings of the below procedure may be used to produce other I-III-VI nanocrystal complexes discussed above. The first step in the preparation of the material is the preparation of an Indium precursor.

In a reaction flask, 292 g/mol of 0.9 Molar indium (III) acetate (99.99% pure), is added to 367 g/mol of 0.1 Molar gallium acetylacetonoate (99% pure) and 256.4 g/mol of 3 Molar palmitic acid (99% pure). The ingredients are mixed and heated to 130° C. for 2 hours under vacuum. The vacuum removes any acetic acid that could form. The resulting indium precursor solution should be clear but may have a yellow tint

Once the indium precursor is prepared, the following materials are placed in a three neck reaction flask:

A) Cu(I) thiolate—30 mg. Instead of Cu(I) thiolate other copper precursors may be used, including Cu(I) acetate. In the event one uses Cu(I) acetate, the copper acetate is first be heated with a dodecanethiol to form a complex prior to mixing with the other material.

B) 1-Octadecene (ODE)—5 ml. ODE is used as a high boiling solvent to allow the reaction to take place. Other non-coordinating high boiling solvents may be used.

C) Dodecanethiol—400 ml. Other thiols or di-thiols that bond strongly to the copper ion may be used.

D) HDA—1 gram. HDA acts a coordinating solvent and may activate the indium precursor.

E) Indium Precursor—1 gram of Indium Precursor prepared above.

Under nitrogen, the flask is heated to 150° C. for three to four minutes. The solution could be clear to reddish brown. 247 ml of (TMS)₂S(1.182×10⁻³) in 1.6 grams of TOP is then injected into the solution. After the injection, the solution is cooled and allowed to rest for approximately 1 minute. The resulting solution is slowly heated up to 200° C. After keeping the solution at 200° C. for approximately 3 minutes, the flask is removed from the heat and allowed to cool.

The solution is added to a centrifuge tube and methanol added. The centrifuge is run at 4,000×g and the supernatant decanted. The retentate is solvated into chloroform. Once solvated in chloroform, a shell may be added using conventional shelling techniques.

The resulting semiconductor nanocrystal complexes may be size separated. This is done by diluting the resulting nanocrystals with chloroform and adding MeOH (˜100 ml) into the mixture until it becomes slightly cloudy. The solution is poured into a syringe and filtered through a 0.45 um PTFE syringe. The retentate is solvated from the syringe filter by using 2.0 ml of chloroform.

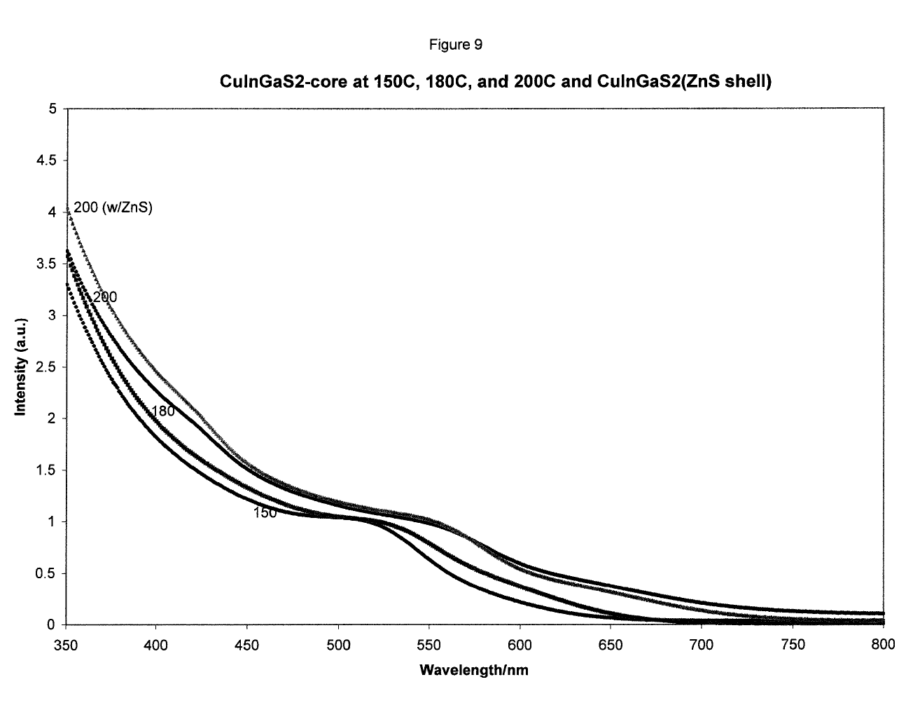

By varying the (TMS)₂S-TOP mixture, injection temperature, one can vary the size of the resulting semiconductor nanocrystal complexes. The graph below represents the various absorption wavelengths for semiconductor nanocrystals made according to the above procedure. As can be seen from FIG. 9, as the injection temperature is increased from 180° C. to 200° C. the wavelength of light absorbed by the nanocrystals also increases. This is due to the fact that as the injection temperature increases the resulting particle size increases. Additionally, the inclusion of a ZnS shell does not materially alter the absorption characteristics of the semiconductor nanocrystal complexes.

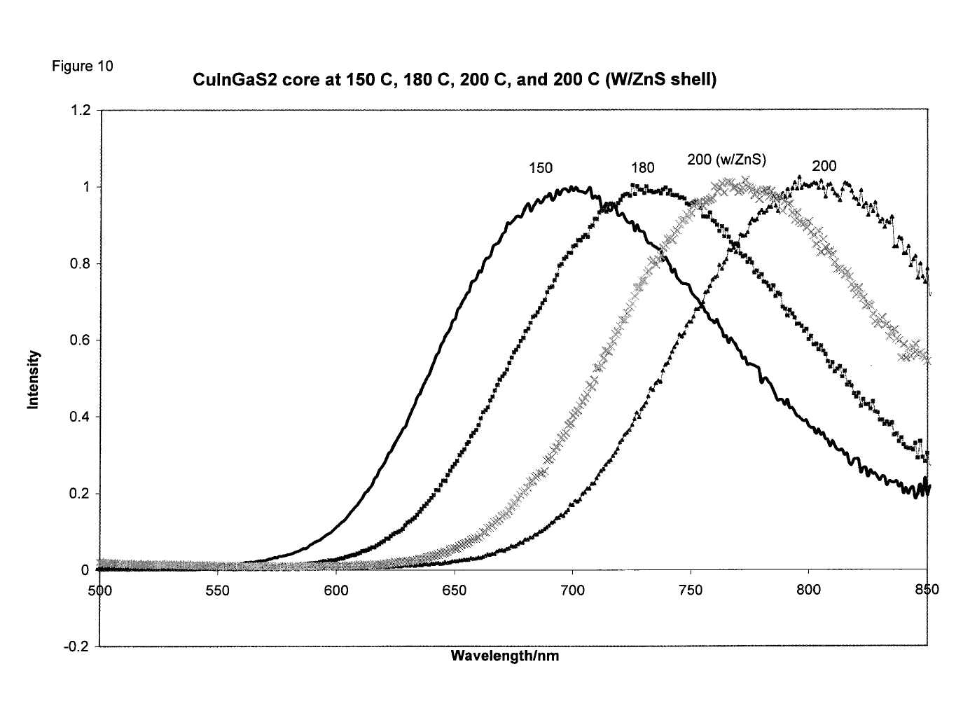

FIG. 10 depicts the emission wavelength of the semiconductor nanocrystal complexes made according to the above described procedure. As can be seen from FIG. 10, I-III-VI semiconductor nanocrystal complexes may be made such that the emission ranges into the near infrared. The emission of the resulting semiconductor nanocrystal complexes increases as the injection temperature increases. Additionally, the addition of a ZnS shell may slightly shift the emission spectra. As can be seen from FIG. 10, the procedure allows the controlled emission of the I-III-VI material through various wavelengths in the near infrared. These wavelengths have traditionally been difficult to reach with traditional quantum dot materials (especially with respect to non-heavy metal materials).

### Example 2

### I-III-VI Semiconductor Nanocrystal Complex

The present example discloses how to prepare a stable, high luminescent quantum yield semiconductor nanocrystal complex comprising a core of CuInGaSe₂. However, like the teachings of the first example the below procedure may be used to produce other I-III-VI nanocrystal complexes discussed above. The first step in the preparation of the material is the preparation of an Indium precursor.

In a reaction flask, 292 g/mol of 0.9 Molar indium (III) acetate (99.99% pure), is added to 367 g/mol of 0.1 Molar gallium acetylacetonoate (99% pure) and 256.4 g/mol of 3 Molar palmitic acid (99% pure). The ingredients are mixed and heated to 130° C. for 2 hours under vacuum. The vacuum removes any acetic acid that could form. The resulting indium precursor solution should be clear but may have a yellow tint.

Once the indium precursor is prepared the following materials are placed in a three neck reaction flask:

A) Cu(I) thiolate—30 mg. Instead of Cu(I) thiolate, other copper precursors may be used, including Cu(I)(acetate). In the event one uses Cu(I) acetate, the copper acetate is first be heated with a dodecanethiol to form a complex prior to mixing with the other material.

B) ODE—5 ml. ODE is used as a high boiling solvent to allow the reaction to take place. Other non-coordinating high boiling solvents may be used.

C) Dodecanethiol—400 ml. Other thiols or di-thiols that bond strongly to the copper ion may be used.

The flask is heated up to 70° C. and allowed to cool. After it cools, the following materials are added to the three neck flask.

D) HDA—1 gram. HDA acts a coordinating solvent and may activate the indium precursor.

E) Indium Precursor—1 gram of Indium Precursor prepared above.

Under nitrogen, the flask is purged for about 5 minutes. The flask is then heated to about 200° C. for two to three minutes. The solution could be clear to yellow brown. Next, 0.4 g of (TBP)Se (25% Se by volume) in 1.6 grams of TOP is then injected into the solution. The solution is removed from heat and allowed to cool to approximately 160° C. for approximately 2 to 3 minutes. The resulting solution is slowly heated up to 200° C. The color changes from pale yellow to yellow to orange and finally red and the total heating time including the time in raising the temperature is approximately 1 hour.

The solution is added to a centrifuge tube and methanol added. The centrifuge is run at 4,000×g and the supernatant decanted. The resulting retentate is solvated into chloroform. Once solvated in chloroform, a ZnS shell may be added using conventional shelling techniques. The resulting semiconductor nanocrystal complexes may be size separated.

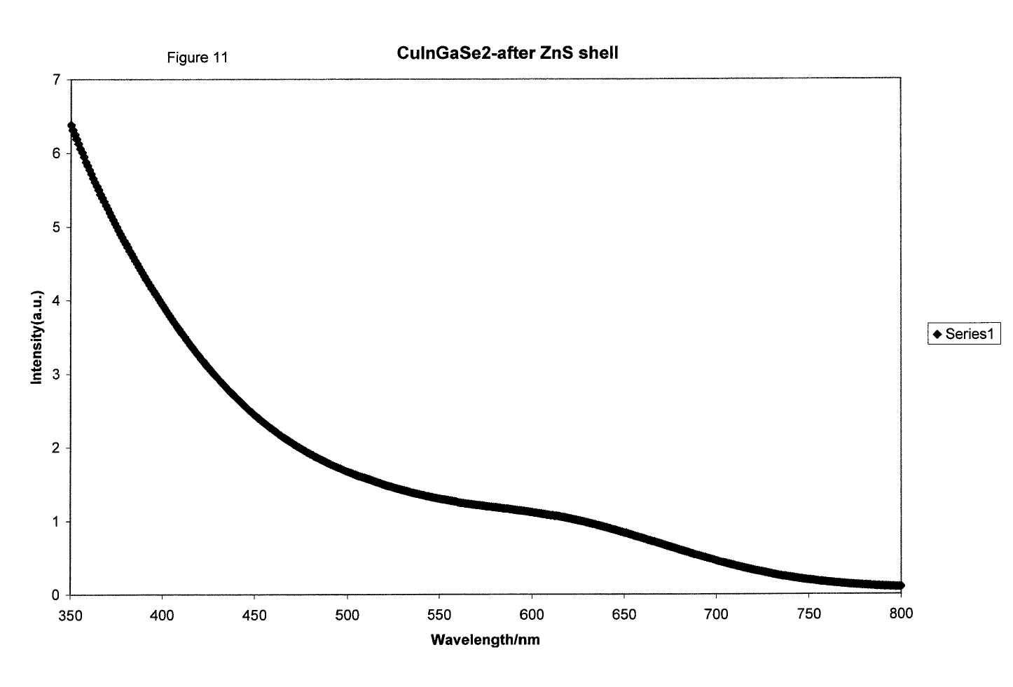

The graphs indicate the results of testing using material made according to the above procedure. FIG. 11 shows the absorption spectrum of CuInGaSe₂ shelled with ZnS. As can be seen from FIG. 11, the material emits light in the near infrared and absorbs light at a value less than the peak emission.

### Example 3

### Zinc Copper Indium Gallium Sulfide Nanocrystal Synthesis

The present example discloses how to prepare a stable, high luminescent quantum yield semiconductor nanocrystal complex comprising a core of ZnCuInGaS₂. However, the teachings of the below procedure may be used to produce other group II alloyed I-III-VI nanocrystal complexes discussed above. The first step in the preparation of the material is the preparation of an Indium precursor.

In a reaction flask, 292 g/mol of 0.9 Molar indium (III) acetate (99.99% pure), is added to 367 g/mol of 0.1 Molar gallium acetylacetonoate (99% pure) and 256.4 g/mol of 3 Molar palmitic acid (99% pure). The ingredients are mixed and heated to 130° C. for 2 hours under vacuum. The vacuum removes any acetic acid that could form. The resulting indium precursor solution should be clear but may have a yellow tint.

Once the indium precursor is prepared, the following materials are placed in a three neck reaction flask:

A) Cu(I) thiolate-100 mg. Instead of Cu(I) thiolate, other copper precursors may be used including Cu(I) acetate. In the event one uses Cu(I) acetate, the copper acetate is first be heated with a dodecanethiol to form a complex prior to mixing with the other material.

B) ODE—5 ml. ODE is used as a high boiling solvent to allow the reaction to take place. Other non-coordinating high boiling solvents may be used.

C) Dodecanethiol—1 ml. Other thiols or di-thiols that bond strongly to the copper ion may be used.

D) Oleylamine—1 ml. Oleylamine acts a coordinating solvent and may activate the indium precursor.

E) Indium Precursor—1 gram of Indium Precursor prepared above.

F) Sulfur Precursor—1 ml 1M S-Oleylamine solution

Into a round bottom flask, the Indium Precursor, Cu thiolate, zinc oleate, oleylamine, dodecane thiol and ODE are added. Vacuum is applied for 2 minutes and then the reaction temperature increased to 180° C. When the solution reaches 180° C., the S precursor is rapidly injected. After 10 minutes the reaction is quenched by cold air. The Zn precursor is then added to the reaction mixture at room temperature. Vacuum is applied and the reaction is heated to 180° C. for 30 minutes.

The solution is added to a centrifuge tube and methanol and acetone added. The centrifuge is run at 4,000×g and the supernatant decanted. The resulting retentate is solvated into chloroform. Once solvated in chloroform, a shell may be added using conventional shelling techniques.

To synthesize a ZCIGS-ZnS core-shell, half of the above ZnCuInGaS₂ (ZCIGS) core products are dissolved in 4 mL toluene and transferred into a microwave tube. The tube is purged by using nitrogen for 10 minutes. The following (TMS)₂S-TOP and zinc oleate-TOP solution are alternatively added to reaction mixture drop by drop at room temperature:
(1) Zinc Precursor—Zinc oleate-TOP=0.08 g (0.125 mmol) in 1 g TOP, and
(2) Sulfur Precursor—Hexamethyldisilathiane (TMS)₂S-TOP=25 μL (0.1185 mmol) in 1 g TOP.
   The reaction mixture is then cooked by microwave for 8 minutes at 300 W and about 230° C. After the reaction mixture cools down, ZCIGS-ZnS core shell nanoparticles are precipitated from toluene by adding acetone, followed by centrifugation. Then they are redispersed in CHCl₃, toluene, hexane or other non-polar solvents.

### Example 4

### Preparing a Water-Stable I-III-VI Semiconductor Nanocrystal Complex

The below described procedures may be used for the development of various water-stable semiconductor nanocrystal complexes. Although specific amounts and temperatures are given in the below described procedures, it is appreciated that these amounts may be varied. The starting material for the below described procedure are the semiconductor nanocrystal compositions prepared and described above.

The below described procedure can be used to produce a water-stable semiconductor nanocrystal complex comprising approximately 3 functional groups. Depending on the size of the semiconductor nanocrystal, the ratio of lipids described below may be varied to get the appropriate number of functional groups.

### Example 4a

### Carboxy Terminated Water Stable I-III-V Semiconductor Nanocrystal Complexes

Solution 1. 2.2 mg of any of the semiconductor nanocrystal compositions described above in toluene solution are loaded into a 15 ml centrifuge tube, and 10 ml methanol is added. The solution is mixed, and centrifuged at 4000 rpm for 3 minutes. The supernatant is removed carefully and 3 ml of hexane is added to re-dissolve the pellet of the nanocrystals. Then 9 ml methanol is added in the tube to precipitate down the nanocrystals again. The hexane and methanol purification steps are repeated one more time. The precipitate pellet is dried, and then re-dissolved into 1 ml chloroform.

Solution 2. 10 mg DSPE-PEG(2000)Carboxylic Acid(1,2-Distearoyl-sn-Glycero-3-Phosphoethanolamine-N-[Carboxy(Polyethyl-ene Glycol)2000] (Ammonium Salt)) and 60 mg mPEG2000PE ([1,2-diacyl-sn-glycero-3-phosphoethanolamine-n-methoxy(polyethylene glycol)-2000] (Ammonium Salt)) lipids are dissolved in 3 ml chloroform solution. It has been found that a 1/6 ratio of carboxy lipid to ammonium salt lipid allows for an optimal number of functional groups, approximately three. However, these ratios may be varied depending on the number of functional groups desired on the semiconductor nanocrystal complex.

Solution 1 and solution 2 are mixed together in a 20 ml vial and the resultant solution dried under N₂. The vial is rotated slowly to make a thin film on the wall while the solution is drying. The vial is heated at 75° C. in a water bath for 2 minutes. To the heated vial, 5 ml deionized water, which has been preheated to 75° C., is added. Then the vial is capped, and the solution is vortexed until all the nanocrystals are dissolved. Then the solution is sonicated for 1 minute.

The solution is transferred into a 15 ml centrifuge tube, centrifuged at 4000 rpm for 5 minutes. The clear supernatant is loaded into a 10 ml syringe, and is filtrated through a 0.2 μm filter. Afterwards, the filtrated solution is loaded into two 11 ml ultracentrifuge tubes and centrifuged at 65000 rpm for 1 hour. The supernatant is removed carefully, and the precipitates is re-dissolved into deionized water. The ultracentrifuge purification step is repeated one more time. The pellets are reconstituted into 4 ml deionized water and stored at 4° C.

### Example 4b

### Amine Terminated Water-Stable I-III-V Semiconductor Nanocrystal Complexes

Solution 1. 2.2 mg of any of the semiconductor nanocrystal compositions described above is loaded into a 15 ml centrifuge tube, and 10 ml methanol is added. The solution is mixed, and centrifuged at 400 rpm for 3 minutes. The supernatant is removed carefully and 3 ml of hexane is added to re-dissolve the pellet of the nanocrystals. Then 10 ml methanol is added in the tube to precipitate down the nanocrystals again. The hexane and methanol purification steps are repeated one more time. The precipitate pellet is dried and then re-dissolved in 1 ml chloroform.

Solution 2. 10 mg DSPE-PEG(2000)Amine (1,2-Distearoyl-sn-Glycero-3-Phosphoethanolamine-N-[Amino(Polyethylene Glycol)2000] (Ammonium Salt)) and 60 mg mnPEG2000PE ([1,2-diacyl-sn-glycero-3-phosphoethanolamine-n-methoxy(polyethylene glycol)-2000] (Ammonium Salt)) lipids are dissolved in 3 ml chloroform solution. It has been found that a 1/6 ratio of amine lipid to ammonium salt lipid allows for an optimal number of functional groups. However, these ratios may be varied depending on the number of functional groups desired on the semiconductor nanocrystal complex. Solution 1 and solution 2 are mixed together in a 20 ml vial and the resultant solution was dried under N₂. The vial is rotated slowly to make a thin film on the wall while the solution is drying. The vial is heated at 75° C. in a water bath for 2 minutes. To the heated vial, 5 ml deionized water, which had been preheated to 75° C., is added. Then the vial is capped, and the solution is vortexed until all the nanocrystals are dissolved. Then the solution is sonicated for 1 minute.

The solution is transferred into a 15 ml centrifuge tube, centrifuged at 4000 rpm for 5 minutes. The clear supernatant is loaded into a 10 ml syringe, and is filtrated through a 0.2 μm filter. Afterwards, the filtrated solution is loaded into two 11 ml ultracentrifuge tubes, centrifuged at 65000 rpm for 1 hour. The supernatant is removed carefully, and re-dissolved into deionized water. The ultracentrifuge purification step is repeated one more time and the pellets are reconstituted into 4 ml deionized water and stored at 4° C.

### Example 4c

### Biotin Terminated Water-Stable I-III-V Semiconductor Nanocrystal Complexes

Solution 1. 2.2 mg of any of the semiconductor nanocrystal compositions described above is loaded into a 15 ml centrifuge tube, and 10 ml methanol is added. The solution is mixed, and centrifuged at 400 rpm for 3 minutes. The supernatant is removed and 3 ml of hexane is added to re-dissolve the pellet of the nanocrystals. Then 9 ml methanol is added into the tube to precipitate down the nanocrystals again. The hexane and methanol purification step are repeated one more time. The precipitate pellet is dried under air, and then re-dissolved into 1 ml chloroform.

Solution 2. 10 mg DPPE-PEG(2000) biotin lipids(1,2-Distearoyl-sn-Glycero-3-Phosphoethanolamine-N-[Biotinyl(Polyet-hylene Glycol)2000(Ammonium Salt)) and 60 mg mPEG2000PE ([1,2-d]acyl-sn-glycero-3-phosphoethanolamine-n-methoxy(polyethylene glycol)-2000] (Ammonium Salt)) lipids are dissolved in 3 ml chloroform solution. It has been found that a 1/6 ratio of biotin lipid to ammonium salt lipid allows for an optimal number of functional groups, approximately three in this example. However, these ratios may be varied depending on the number of functional groups desired on the semiconductor nanocrystal complex.

Solution 1 and solution 2 were mixed together in a 20 ml vial and the resultant solution are dried under N₂. The vial was rotated slowly to make a thin film on the wall while the solution is drying. The vial is heated at 75° C. in a water bath for 2 minutes. To the heated vial, 5 ml deionized water which has been preheated to 75° C. is added. Then the vial is capped, and the solution is vortexed until all the nanocrystals were dissolved. Then the solution is sonicated for 1 minute.

The solution is transferred into a 15 ml centrifuge tube, centrifuged at 4000 rpm for 5 minutes. The clear supernatant is loaded into a 10 ml syringe, and is filtrated through a 0.2 μm filter. Afterwards, the filtrated solution is loaded into two 11 ml ultracentrifuge tubes, centrifuged at 65,000 rpm for 1 hour. The supernatant is removed carefully, and the precipitates are re-dissolved into deionized water. The ultracentrifuge purification step is repeated one more time. The pellets are reconstitute into 4 ml deionized water and stored at 4° C.

The foregoing description and examples have been set forth merely to illustrate the invention and are not intended as being limiting. Each of the disclosed aspects and embodiments of the present invention may be considered individually or in combination with other aspects, embodiments, and variations of the invention. In addition, unless otherwise specified, none of the steps of the methods of the present invention are confined to any particular order of performance. Modifications of the disclosed embodiments incorporating the spirit and substance of the invention may occur to persons skilled in the art and such modifications are within the scope of the present invention. Furthermore, all references cited herein are incorporated by reference in their entirety.

What is claimed is:

1. A semiconductor nanocrystal composition comprising:
a semiconductor nanocrystal core comprising a I-III-VI semiconductor material, wherein the semiconductor nanocrystal composition is electronically and chemically stable with a luminescent quantum yield of at least 10%.

2. The semiconductor nanocrystal composition of claim 1, wherein the semiconductor nanocrystal core has an outer surface and the semiconductor nanocrystal composition further comprises:
a metal layer formed on the outer surface of the semiconductor nanocrystal core.

3. The semiconductor nanocrystal composition of claim 1, wherein the semiconductor nanocrystal core has an outer surface and the semiconductor nanocrystal composition comprises:
a shell comprising a semiconductor material formed on the outer surface of the semiconductor nanocrystal core.

4. The semiconductor nanocrystal composition of claim 1, wherein the semiconductor nanocrystal core has an outer surface and the semiconductor nanocrystal composition comprises:
a metal layer formed on the outer surface of the semiconductor nanocrystal core; and
a shell comprising a semiconductor material overcoating the metal layer.

5. The semiconductor nanocrystal composition of claim 1, wherein the semiconductor nanocrystal core has an outer surface and the semiconductor nanocrystal composition comprises:
a metal layer formed on the outer surface of the semiconductor nanocrystal core; and
an outer coating comprising an anion layer overcoating the metal layer and a second metal layer overcoating the anion layer.

6. The semiconductor nanocrystal composition of claim 1, wherein the semiconductor nanocrystal core comprises a quaternary semiconductor material.

7. The semiconductor nanocrystal composition of claim 6, wherein the quaternary semiconductor material is CuInGaS₂ or CuInGaSe₂.

8. The semiconductor nanocrystal composition of claim 1, wherein the luminescent quantum yield is at least 25%.

9. The semiconductor nanocrystal composition of claim 1, wherein the luminescent quantum yield is at least 45%.

10. The semiconductor nanocrystal composition of claim 1, wherein the luminescent quantum yield is at least 60%.

11. A substantially monodisperse population of semiconductor nanocrystal compositions, each semiconductor nanocrystal composition comprising:
a semiconductor nanocrystal core, the semiconductor nanocrystal core comprising a I-III-VI semiconductor material, wherein the semiconductor nanocrystal composition is stable with a luminescent quantum yield of at least 10%.

12. A method of making a semiconductor nanocrystal composition comprising:
synthesizing a semiconductor nanocrystal core comprising a I-III-VI semiconductor material having an outer surface; and
forming a metal layer on the outer surface of the semiconductor nanocrystal core after synthesis of the semiconductor nanocrystal core, wherein the semiconductor nanocrystal composition has a luminescent quantum yield of at least 10%.

13. The method of claim 12, further comprising overcoating the metal layer with a shell comprising a semiconductor material.

14. A water-stable semiconductor nanocrystal complex comprising:
the semiconductor nanocrystal composition of claim 1;
a surface layer comprising molecules having a moiety with an affinity for the semiconductor nanocrystal composition and a moiety with an affinity for a hydrophobic solvent; and
a water-stabilizing layer having a hydrophobic end for interacting with the surface layer and a hydrophilic end for interacting with an aqueous medium.

15. The semiconductor nanocrystal complex of claim 14, wherein the water-stabilizing layer is a diblock polymer coating surrounding the surface-coated semiconductor nanocrystal, the diblock polymer coating comprising a plurality of diblock polymers, each of the plurality of diblock polymers having a hydrophobic end for noncovalently interacting with the surface-coated semiconductor nanocrystal and a hydrophilic end for interacting with an aqueous medium.

16. The semiconductor nanocrystal complex of claim 15, wherein adjacent ones of the plurality of diblock polymers are linked together by a bridging molecule.

17. The semiconductor nanocrystal complex of claim 16, wherein the bridging molecule is bis 2,2′-(ethylenedioxy)bis(ethylamine).

18. The semiconductor nanocrystal complex of claim 15, wherein the diblock polymer is poly(butadiene (1,4 addition)-b-acrylic acid).

19. The semiconductor nanocrystal complex of claim 19, wherein the hydrophilic end comprises functional groups for coupling to one or more tertiary molecules.

20. The semiconductor nanocrystal complex of claim 20, wherein the one or more tertiary molecule is a member of a specific binding pair.

21. The semiconductor nanocrystal complex of claim 20, wherein the member of the specific binding pair is selected from the group consisting of antibody, antigen, hapten, antihapten, biotin, avidin, streptavidin, IgG, protein A, protein G, drug receptor, drug, toxin receptor, toxin, carbohydrate, lectin, peptide receptor, peptide, protein receptor, protein, carbohydrate receptor, carbohydrate, polynucleotide binding protein, polynucleotide, DNA, RNA, aDNA, aRNA, enzyme, substrate, or combinations thereof.

22. The semiconductor nanocrystal complex of claim 14, wherein the water-stabilizing layer is a layer of PEGylated phospholipids.

23. A method of manufacturing a water-stable semiconductor nanocrystal complex comprising:
synthesizing a semiconductor nanocrystal composition according to the method of claim 12;
adding a surface layer to the semiconductor nanocrystal composition, the surface layer comprising molecules having a moiety with an affinity for the surface of the semiconductor nanocrystal composition and another moiety with an affinity for a hydrophobic solvent; and
adding a water-stabilizing layer to the surface layer, the water-stabilizing layer having a hydrophobic end for interacting with the surface layer and a hydrophilic end for interacting with an aqueous medium.
